(19) United States
(12) Patent Application Publication
(10) Pub. No.: US 2020/0204047 A1
(43) Pub. Date: Jun. 25, 2020

(54) STATOR STACKING FIXTURE

(71) Applicant: Moog Inc., East Aurora, NY (US)

(72) Inventor: Ping Peter Zhong, Amherst, NY (US)

(21) Appl. No.: 16/644,429

(22) PCT Filed: Sep. 12, 2018
(86) PCT No.: PCT/US2018/050699

§ 371 Date: Mar. 4, 2020

Related U.S. Application Data
(60) Provisional application No. 62/559,140, filed on Sep. 15, 2017.

(51) Int. Cl. H02K 15/02

(52) U.S. Cl. CPC H02K 15/02

(57) ABSTRACT

Embodiments of the present disclosure present a method and apparatus for forming a stator. An exemplary apparatus includes a planar ring defining a hollow center portion adjacent to an inner radius edge, the inner radius edge comprising a plurality of spaced apart tracks extending radially outward from the inner radius edge along a face of the planar ring. The apparatus further includes In a plurality of vertical bars, each one of the plurality of vertical bars removeably attached to the planar ring at one of the plurality of spaced apart tracks. The apparatus still further includes at least one support ring removeably attached to the plurality of vertical bars, the at least one support ring attached to each one of the plurality of vertical bars along either an inner radial surface and a top surface.

### BACKGROUND OF THE INVENTION

### Field of the Invention

Exemplary embodiments of the present disclosure relate to a method and apparatus for a stator stacking fixture. Embodiments of the present disclosure relate more particularly to a method and apparatus for a stator stacking fixture operable to form a stator.

### Description of Related Art

A stator is generally a stationary element or part of a rotary system. Examples of stators are commonly found in electric motors and electric generators. The main use of stators are to maintain the electric field from the motors or generators aligned.

### BRIEF SUMMARY OF THE INVENTION

In view of the foregoing, it is an object of the present disclosure to provide a method and apparatus for forming a stator.

A first exemplary embodiment of the present disclosure provides an apparatus. The apparatus includes planar ring defining a hollow center portion adjacent to an inner radius edge, the inner radius edge comprising a plurality of spaced apart tracks extending radially outward from the inner radius edge along a face of the planar ring, and a plurality of vertical bars, each one of the plurality of vertical bars removeably attached to the planar ring at one of the plurality of spaced apart tracks. The apparatus further includes at least one support ring removeably attached to the plurality of vertical bars, the at least one support ring attached to each one of the plurality of vertical bars along either an inner radial surface and a top surface.

A second exemplary embodiment of the present disclosure provides a method of forming. The method includes providing a planar ring defining a hollow center portion adjacent to an inner radius edge, the inner radius edge comprising a plurality of spaced apart tracks extending radially outward from the inner radius edge along a face of the planar ring, and providing a plurality of vertical bars, each one of the plurality of vertical bars removeably attached to the planar ring at one of the plurality of spaced apart tracks. The method further provides providing at least one support ring removeably attached to the plurality of vertical bars, the at least one support ring attached to each one of the plurality of vertical bars along either an inner radial surface and a top surface.

A third exemplary embodiment of the present disclosure provides a method of manufacture. The method includes providing a planar ring defining a hollow center portion adjacent to an inner radius edge, the inner radius edge comprising a plurality of spaced apart tracks extending radially outward from the inner radius edge along a face of the planar ring, and slideably attaching a plurality of vertical bars to each one of the plurality of spaced apart tracks, each one of the plurality of vertical bars removeably attached to the planar ring at one of the plurality of spaced apart tracks. The method further includes removeably attaching at least one support ring to the plurality of vertical bars, the at least one support ring attached to each one of the plurality of vertical bars along either an inner radial surface and a top surface. The method still further includes forming a stator on a planar ring around the plurality of vertical bars, and slideably removing the plurality of vertical bars from the planar ring.

The following will describe embodiments of the present disclosure, but it should be appreciated that the present disclosure is not limited to the described embodiments and various modification of the invention are possible without departing from the basic principles. The scope of the present disclosure is therefore to be determined solely by the appended claims.

### BRIEF DESCRIPTION OF THE SEVERAL VIEWS OF THE DRAWING(S)

FIG. 1 is a top perspective view of an exemplary fixture suitable for performing exemplary embodiments of the present disclosure.

FIG. 2 is a bottom perspective view of an exemplary fixture suitable for performing exemplary embodiments of the present disclosure.

FIG. 3 is a top perspective view of an exemplary fixture in another configuration suitable for performing exemplary embodiments of the present disclosure.

FIG. 4 is another top perspective view of an exemplary fixture suitable for performing exemplary embodiments of the present disclosure.

FIG. 5 is a side view of an exemplary ring of a fixture suitable for performing exemplary embodiments of the present disclosure.

FIG. 6 is a top perspective view of an exemplary ring of a fixture suitable for performing exemplary embodiments of the present disclosure.

FIG. 7 is a separated view of an exemplary fixture and a stator suitable for performing exemplary embodiments of the present disclosure.

FIG. 8 is a side perspective view of an exemplary fixture and a stator suitable for performing exemplary embodiments of the present disclosure.

FIG. 9 is a side cross sectional view of an exemplary fixture suitable for performing exemplary embodiments of the present disclosure.

FIG. 10 is a close-up side cross sectional view of an exemplary fixture suitable for performing exemplary embodiments of the present disclosure.

FIG. 11 is a close-up perspective view of the ring and a vertical bar of an exemplary fixture suitable for performing exemplary embodiments of the present disclosure.

FIG. 12 is a logic flow diagram in accordance with a method and apparatus for performing exemplary embodiments of the present disclosure.

FIG. 13 is another logic flow diagram in accordance with a method and apparatus for performing exemplary embodiments of the present disclosure.

### DETAILED DESCRIPTION OF THE INVENTION

There are various geometries for magnetic electric motors. One geometry is the linear magnetic motor. In a linear magnetic motor, a shaft is driven to move linearly (that is, as a straight-line translation) with respect to a stator. Another geometry is a rotary magnetic motor. In a rotary magnetic motor, a rotor is driven to rotate relative to a stator. Conventional rotary electric magnetic motors generally include a stator assembly and a rotor that is driven to rotate with respect to the stator assembly. Typically, the rotor is at least partially surrounded by the stator and the rotor generates a magnetic field by virtue of having a series of built in permanent magnets. The stator generates magnetic fields through a series of coils or windings. By timing the flow of current in the coils with respect to the position and/or momentum of the rotor, the interaction of magnetic forces from the rotor and from the stator will rotate the rotor. Thus, in magnetic motors, magnetic fields are formed in both the rotor and the stator. The product between these two fields gives rise to a force, and thus a torque on the motor rotor or shaft. The rotor thereby moves through the field of the stator due to magnetic forces generated by energized coils in the stator. Thus, a conventional electric motor includes a generally cylindrical outer stator core, stator coils wound within the stator core, and an inner rotor having permanent magnets and that moves relative to the stator core so as to provide motion by means of interaction with the magnetic field of the stator.

The stator conventionally includes at least one coil wound in at least one stator core. The purpose of the stator coils is to generate magnetic flux that interacts with permanent magnets on the rotor. Various stator assembly configurations are known. The stator may be built by stacking module parts, or may be formed from radially-extending laminates, as well as by other methods. The stator core is typically made up of many thin metal sheets, called laminations. Laminations are used to reduce energy losses that would result if a solid core were used.

Embodiments of the present disclosure provide a stator fixture, which includes removeable vertical bars that allow a stator to be formed and then removed from a stator fixture with a reduced risk of damage to the stator. Embodiments of the present disclosure provide a stator fixture having vertical bars that can be affixed to a planar ring in one configuration and can be slideably removed radially inward from the planar ring after a stator core has been formed on the planar ring and around the vertical bars.

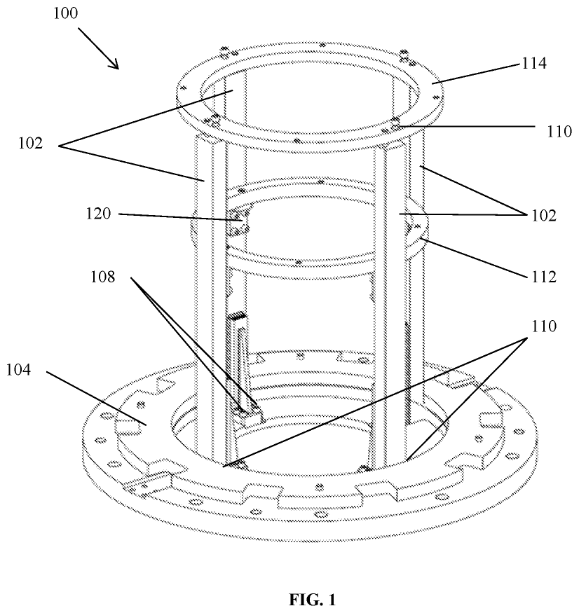

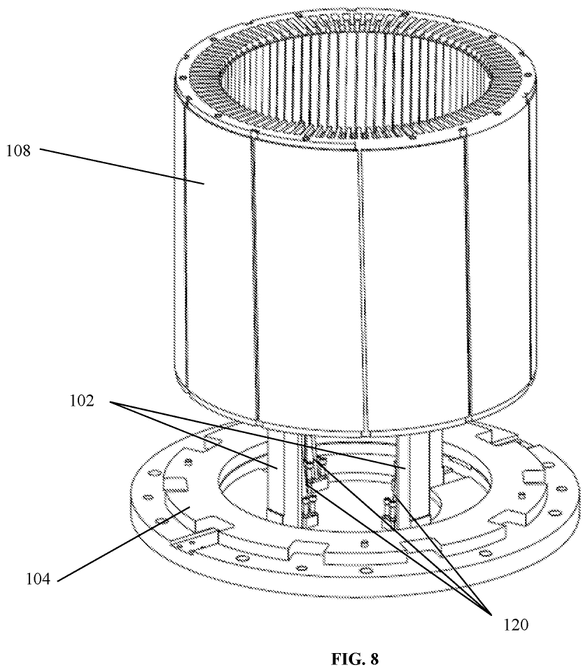

Referring to FIG. 1, shown is a side perspective view of a stator fixture 100. Stator fixture 100 includes a plurality of vertical bars 102 slideably removeably attached to a ring 104 at tracks 112. Each of the vertical bars 102 when affixed to the ring 104 (as shown in FIGS. 1, 2 and 8) provide a template for building or constructing stator laminates 106 (shown in FIGS. 7 and 8) around. In other words, stator laminates 106 can be built, constructed, or formed on the ring 104 and around the vertical bars 102 to form a stator core 108. Vertical bars 102 are removably and slideably attached to the ring 104 along tracks 112 such that they can be fixedly attached to the ring 104 in one position (e.g., through the use of screws/bolts 110). Vertical bars 102 are also able to be slideably removed from ring 104 by sliding radially inward with respect to the ring 104 in a second position (e.g., when the screws/bolts 110 are removed). Vertical bars 102 can be fixedly attached to ring 104 through any known removeable means such as screws and/or bolts 110.

Ring 104 is a planar ring defining a hollow center portion that is adjacent an inner radius edge. The inner radius edge includes a plurality of tracks 112 extending radially outward along a face of ring 104. Tracks 112 provide a trough or area for vertical bars 102 to radially slide through such that they can be fixedly attached and slideably removed from ring 104. Tracks 112 include a plurality of holes 124 operable for interacting with screws/bolts 110 for removeably affixing vertical bars 102 to ring 104.

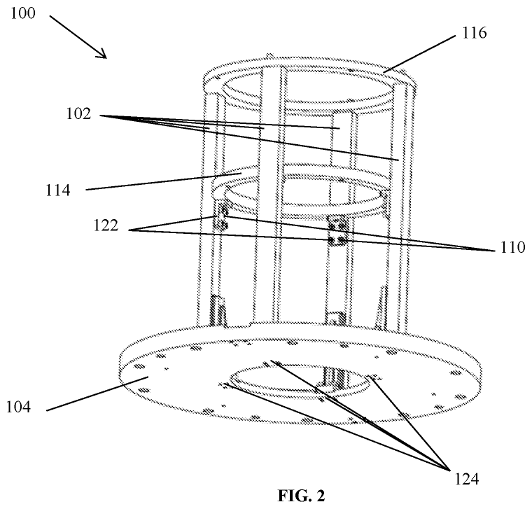

Stator fixture 100 can also include one or more support rings 114 (shown in FIGS. 1 and 2) and a top support ring 116 (shown in FIGS. 1 and 2). Support ring 114 is removeably affixed to vertical bars 102 through the use of screws/bolts 110 and ring brace 120. Ring brace 120 is removeably affixed to an interior surface of vertical bars 102 through the use of screws/bolts 110. Ring brace 120 provides a planar surface operable to maintain a location of support ring 114. Ring brace 120 is removeably affixed to vertical bars 102 such that support ring 114 is substantially prevented by ring brace 120 from moving closer towards ring 104. Support ring 114 aids in the prevention of bowing or bending of vertical bars 102 and thus aids in maintaining the relative distance between each one of the vertical bars 102. Top support ring 116 is removably attached to vertical bars 102 through the use of screws/bolts 110 and top pins 118 that extend from an end of vertical bars 102. Similar to support ring 114, top support ring 116 aids in the prevention of bowing or bending of vertical bars 102 and aids in maintaining the relative distance between each one of the vertical bars 102. In other words, support ring 114 and top support ring 114 substantially maintain the same relative distance between vertical bars 102 as is found at the point of contact between vertical bars 102 and ring 104.

Vertical bars 102, ring 104, support rings 114, and top support ring 116 in combination are operable to maintain the location of each stator laminate 106 of the stator core 108 within a given stack of laminates 106 such that the stator laminates 106 do not move with respect to one another. Vertical bars 102, ring 104, support rings 114, and top support ring 116 also maintain the location of each laminate 106 during construction of the laminated stator core 108.

Referring to FIG. 2, depicted is a bottom perspective view of an exemplary stator fixture 100. Shown in FIG. 2 are holes 124 operable to interact with screws/bolts 110 for removeably affixing vertical bars 102 to ring 104 along tracks 112. It should be appreciated that holes 124 as depicted in FIG. 2 provide a passage from a top end of ring 104 to a bottom end of ring 104, embodiments include holes 124 only providing a passage from a top end of ring 104 and thus do not pass through all of ring 104.

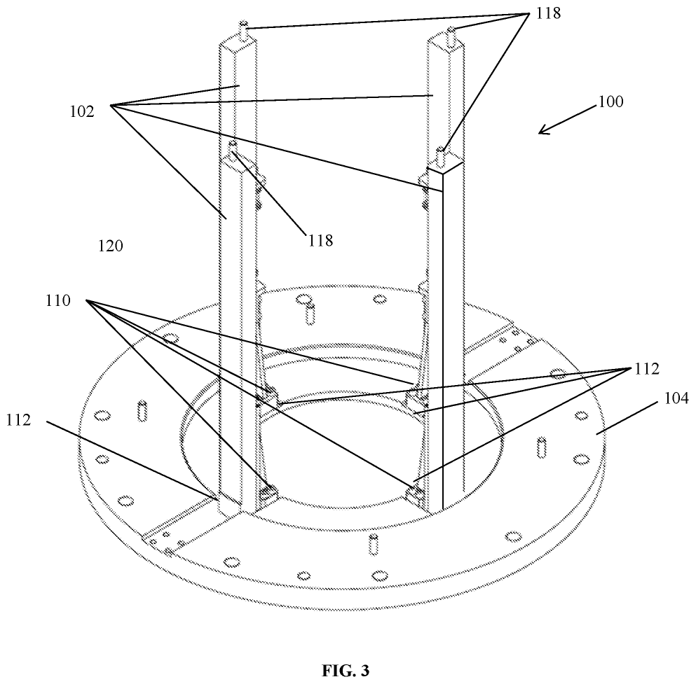

Referring to FIG. 3, shown is stator fixture 100 without support ring 114 and top support ring 116. As can been seen, a top end of vertical bars 102 include top pins 118 operable to intersect corresponding holes within top support ring 116. Embodiments of top pins 118 provide a means for easily locating top support ring 116 to vertical bars thereby removeably maintaining a location of top support ring 116 on vertical bars 102 while it is affixed through bolts/screws 110.

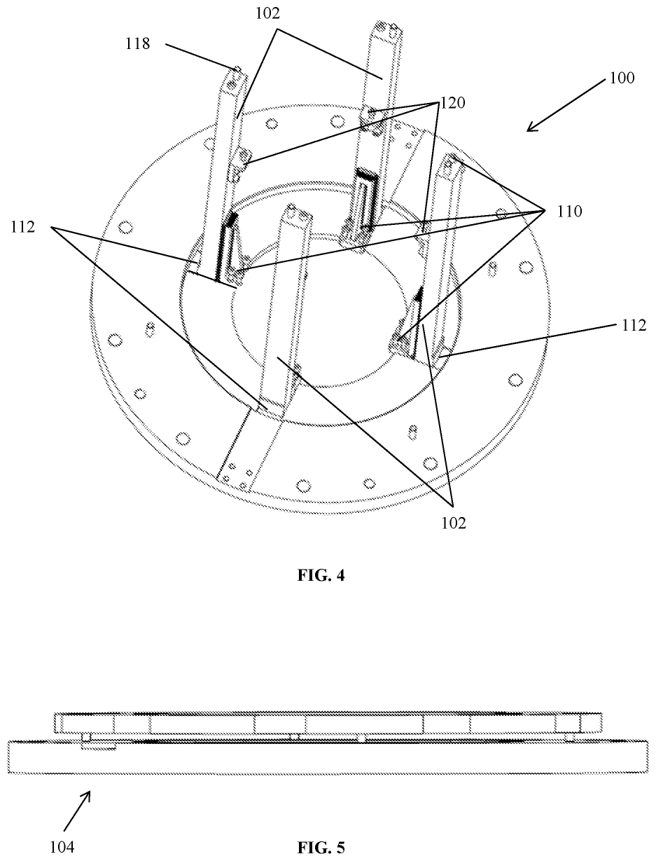

Referring to FIG. 4, shown is a top perspective view of stator fixture 100 without support ring 114 and top support ring 116. Shown in FIG. 4 are ring braces 120 fixedly attached to vertical bars 102 along a radially interior surface of vertical bars 102. Each ring brace 120 has a top planar surface and at least one screw/bolt 110 and corresponding screw/bolt hole operable for removeably affixing support ring 114 to ring brace 120. Also shown in FIG. 4 are screw/bolts 110 along with screw/bolt holes at a top end of vertical bars 110.

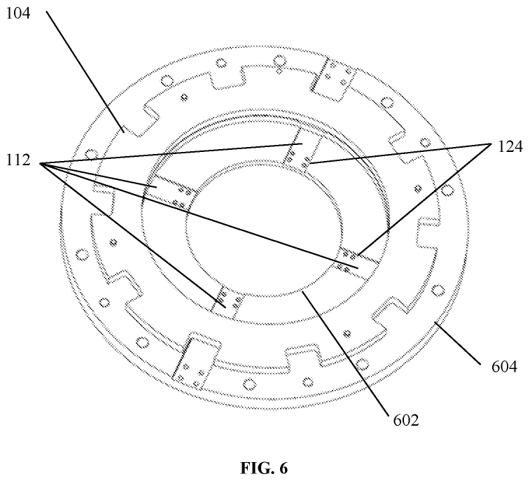

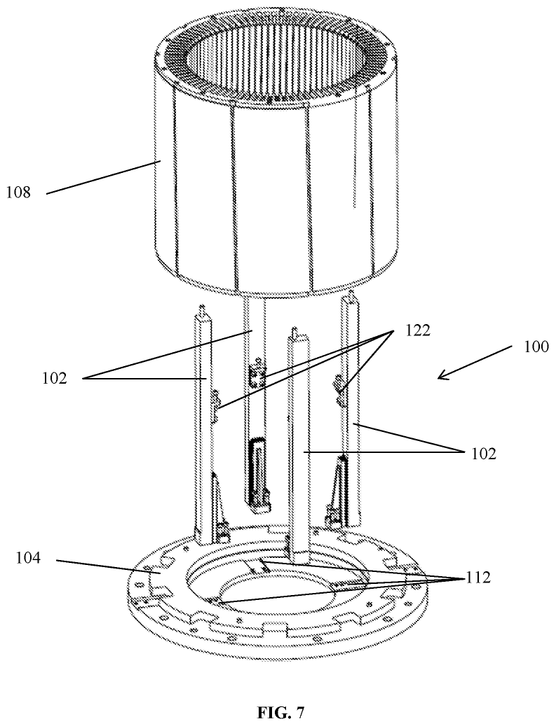

Shown in FIG. 5 is a side view of ring 104. Shown in FIG. 6 is a top perspective view of ring 104. As illustrated in FIG. 5, ring 104 includes tracks 112, which extend on a top planar surface of ring 104 from an interior edge 602 radially outward toward an exterior edge 604. Also depicted within each track 112 are holes 124 operable to couple to screws/bolts 110 for removeably affixing vertical bars 102 to ring 104.

Referring to FIG. 7, shown is a separated view of stator fixture 100 and laminate core 108. As illustrated in FIG. 7, once a stator core 108 is constructed on stator fixture 100, vertical bars 102 are operable to slideably detach radially inward from ring 104 and tracks 112. After vertical bars 102 are removed (along with support ring 114 and top support ring 116), stator core 108 is removed from ring 104. Referring to FIG. 8, shown is stator fixture 100 with laminate core 108 surrounding vertical bars 102 over ring 104.

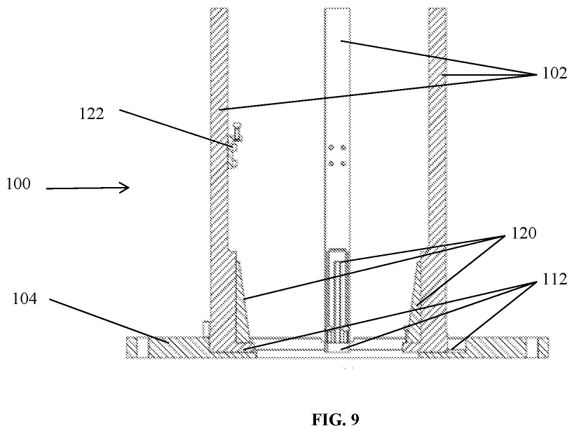

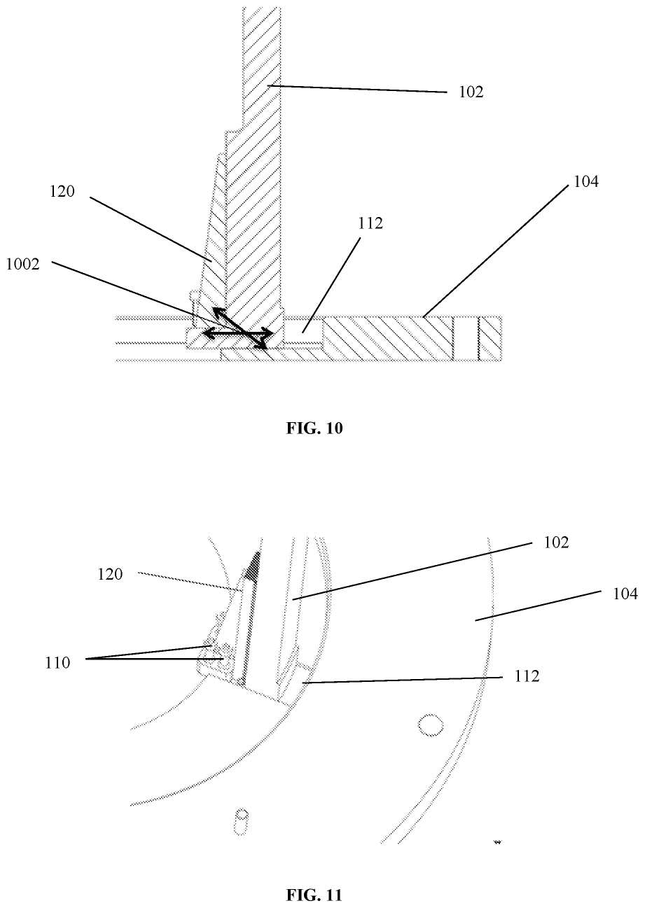

Reference is now made to FIG. 9, which depicts a cross sectional side view of stator fixture 100. As illustrated, ring 104 includes tracks 112 for maintaining and removeably affixing vertical bars 102 to ring 104. Tracks 112 as shown provide a trough or indentation such that vertical bars 102 can be slideably moved through track 112. This is illustrated in FIG. 10, which shows a close up side view of vertical bar 102 and ring 104. As depicted, vertical bars 102 can move through track 112 in the directions indicated by arrow 1002. A partially removed view of vertical bar 102 from track 112 is depicted in FIG. 11. It should be appreciated that embodiments of vertical bars 102, ring 104 and tracks 112 provide that vertical bars 102 can move in any direction radially inward and they need not slide directly radially inward.

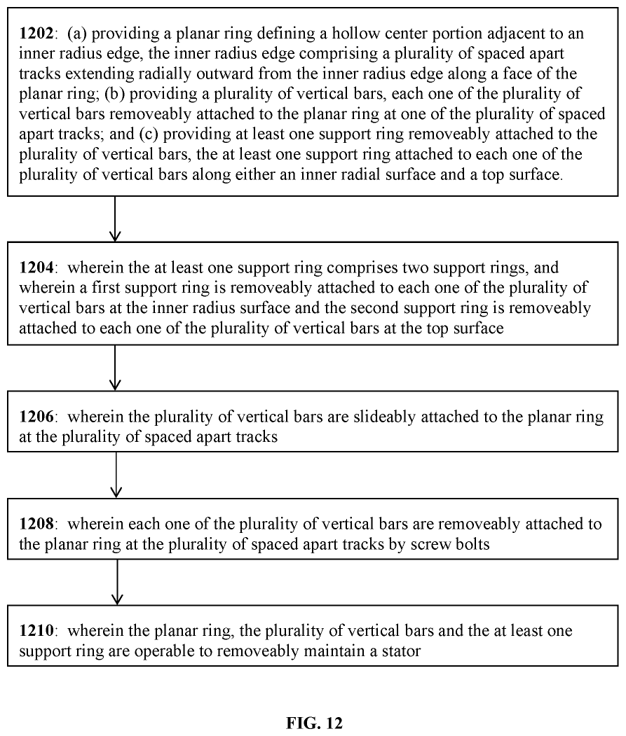

Reference is now made to FIG. 12, which presents a logic flow diagram in accordance with an exemplary process for providing a stator fixture 100. The process begins at block 1202 which states (a) providing a planar ring defining a hollow center portion adjacent to an inner radius edge, the inner radius edge comprising a plurality of spaced apart tracks extending radially outward from the inner radius edge along a face of the planar ring; (b) providing a plurality of vertical bars, each one of the plurality of vertical bars removeably attached to the planar ring at one of the plurality of spaced apart tracks; and (c) providing at least one support ring removeably attached to the plurality of vertical bars, the at least one support ring attached to each one of the plurality of vertical bars along either an inner radial surface and a top surface. Next at block 1204, the process continues wherein the at least one support ring comprises two support rings, and wherein a first support ring is removeably attached to each one of the plurality of vertical bars at the inner radius surface and the second support ring is removeably attached to each one of the plurality of vertical bars at the top surface.

Following block 1204, block 1206 specifies wherein the plurality of vertical bars are slidably attached to the planar ring at the plurality of spaced apart tracks. Then block 1208 relates to wherein each one of the plurality of vertical bars are removeably attached to the planar ring at the plurality of spaced apart tracks by screw bolts. Block 1210 states wherein the planar ring, the plurality of vertical bars and the at least one support ring are operable to removeably maintain a stator.

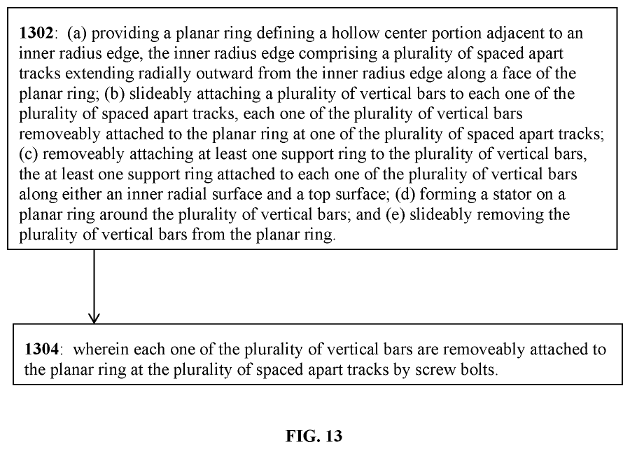

Referring to FIG. 13, shown is another logic flow diagram in accordance with an exemplary process for providing a stator fixture 100. Block 1302 specifies (a) providing a planar ring defining a hollow center portion adjacent to an inner radius edge, the inner radius edge comprising a plurality of spaced apart tracks extending radially outward from the inner radius edge along a face of the planar ring; (b) slideably attaching a plurality of vertical bars to each one of the plurality of spaced apart tracks, each one of the plurality of vertical bars removeably attached to the planar ring at one of the plurality of spaced apart tracks; (c) removeably attaching at least one support ring to the plurality of vertical bars, the at least one support ring attached to each one of the plurality of vertical bars along either an inner radial surface and a top surface; (d) forming a stator on a planar ring around the plurality of vertical bars; and (e) slideably removing the plurality of vertical bars from the planar ring. Following block 1302, block 1304 states wherein each one of the plurality of vertical bars are removeably attached to the planar ring at the plurality of spaced apart tracks by screw bolts.

It is to be understood that any feature described in relation to any one embodiment may be used alone, or in combination with other features described, and may also be used alone, or in combination with one or more features of any other of the embodiments, or any combination of any other of the embodiments. The presently disclosed embodiments are therefore considered in all respects to be illustrative. Furthermore, equivalents and modifications not described above may also be employed without departing from the scope of this disclosure, which is defined in the accompanying claims.

1. An apparatus for forming a stator, the apparatus comprising:
a planar ring defining a hollow center portion adjacent to an inner radius edge, the inner radius edge comprising a plurality of spaced apart tracks extending radially outward from the inner radius edge along a face of the planar ring;
a plurality of vertical bars, each one of the plurality of vertical bars removeably attached to the planar ring at one of the plurality of spaced apart tracks; and
at least one support ring removeably attached to the plurality of vertical bars, the at least one support ring attached to each one of the plurality of vertical bars along either an inner radial surface and a top surface.

2. The apparatus according to claim 1, wherein the at least one support ring comprises two support rings, and wherein a first support ring is removeably attached to each one of the plurality of vertical bars at the inner radius surface and the second support ring is removeably attached to each one of the plurality of vertical bars at the top surface.

3. The apparatus according to claim 1, wherein the plurality of vertical bars are slideably attached to the planar ring at the plurality of spaced apart tracks.

4. The apparatus according to claim 1, wherein each one of the plurality of vertical bars are removeably attached to the planar ring at the plurality of spaced apart tracks by screw bolts.

5. The apparatus according to claim 1, wherein the planar ring, the plurality of vertical bars and the at least one support ring are operable to removeably maintain a stator.

6. The apparatus according to claim 1, wherein each one of the plurality of vertical bars is operable to be removed from the planar ring while a stator is maintained on the planar ring and around the plurality of vertical bars.

7. A method of forming, the method comprising:
(a) providing a planar ring defining a hollow center portion adjacent to an inner radius edge, the inner radius edge comprising a plurality of spaced apart tracks extending radially outward from the inner radius edge along a face of the planar ring;
(b) providing a plurality of vertical bars, each one of the plurality of vertical bars removeably attached to the planar ring at one of the plurality of spaced apart tracks; and
(c) providing at least one support ring removeably attached to the plurality of vertical bars, the at least one support ring attached to each one of the plurality of vertical bars along either an inner radial surface and a top surface.

8. The method according to claim 7, wherein the at least one support ring comprises two support rings, and wherein a first support ring is removeably attached to each one of the plurality of vertical bars at the inner radius surface and the second support ring is removeably attached to each one of the plurality of vertical bars at the top surface.

9. The method according to claim 7, wherein the plurality of vertical bars are slidably attached to the planar ring at the plurality of spaced apart tracks.

10. The method according to claim 7, wherein each one of the plurality of vertical bars are removeably attached to the planar ring at the plurality of spaced apart tracks by screw bolts.

11. The method according to claim 7, wherein the planar ring, the plurality of vertical bars and the at least one support ring are operable to removeably maintain a stator.

12. A method of manufacture, the method comprising:
(a) providing a planar ring defining a hollow center portion adjacent to an inner radius edge, the inner radius edge comprising a plurality of spaced apart tracks extending radially outward from the inner radius edge along a face of the planar ring;
(b) slideably attaching a plurality of vertical bars to each one of the plurality of spaced apart tracks, each one of the plurality of vertical bars removeably attached to the planar ring at one of the plurality of spaced apart tracks;
(c) removeably attaching at least one support ring to the plurality of vertical bars, the at least one support ring attached to each one of the plurality of vertical bars along either an inner radial surface and a top surface;
(d) forming a stator on a planar ring around the plurality of vertical bars; and
(e) slideably removing the plurality of vertical bars from the planar ring.

13. The method according to claim 12, wherein each one of the plurality of vertical bars are removeably attached to the planar ring at the plurality of spaced apart tracks by screw bolts.
